(19) United States
(12) Patent Application Publication
(10) Pub. No.: US 2013/0100580 A1
(43) Pub. Date: Apr. 25, 2013

(54) ELECTRIC DOUBLE LAYER CAPACITOR

(71) Applicants: Chang Ryul Jung, Seoul (KR); Bae Kyun Kim, Gyeonggi-do (KR); Ho Jin Yun, Gyeonggi-do (KR); Hak Kwan Kim, Seoul (KR); Yeong Su Cho, Gyeonggi-do (KR)

(72) Inventors: Chang Ryul Jung, Seoul (KR); Bae Kyun Kim, Gyeonggi-do (KR); Ho Jin Yun, Gyeonggi-do (KR); Hak Kwan Kim, Seoul (KR); Yeong Su Cho, Gyeonggi-do (KR)

(73) Assignee: SAMSUNG ELECTRO-MECHANICS CO., LTD.

(21) Appl. No.: 13/487,537

(22) Filed: Jun. 4, 2012

(30) Foreign Application Priority Data
Oct. 21, 2011 (KR) 10-2011-0108133

(51) Int. Cl. H01G 9/155

(52) U.S. Cl. 361/502

(57) ABSTRACT

The present invention relates to an electric double layer capacitor including electrodes using a cathode current collector and an anode current collector with different thicknesses.

According to the present invention, the cathode current collector is formed to be relatively thin compared to the anode current collector so that an electrode structure has the two electrode current collectors with different thicknesses. Therefore, it is possible to minimize capacity reduction compared to conventional methods and improve energy density of a cell by improving a withstand voltage of the cell.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0108133, entitled filed Oct. 21, 2011, which is hereby incorporated by reference in its entirety into this application.

### BACKGROUND OF THE INVENTION

1. Field of the Invention

The present invention relates to an electric double layer capacitor.

2. Description of the Related Art

A secondary battery and an electric double layer capacitor (EDLC) are mainly used for advanced functions of electronic products and stable power supply to electric vehicles and home and industrial electronic devices.

However, the secondary battery has low power density compared to the EDLC, causes environmental pollution, and has short charge/discharge cycles and risks of overcharging and exploding at high temperature. Therefore, in order to overcome these problems, recently, development of a high performance EDLC with improved energy density is actively in progress.

Recently, as application fields of the EDLC, the market is expanding to systems requiring independent power supply devices, systems of adjusting instantaneous overload, energy storage devices, and so on.

Especially, since the EDLC is highlighted in terms of excellent energy input/output (power density) compared to the secondary battery, application of the EDLC is expanding to a back-up power supply, that is, an auxiliary power supply which operates in instantaneous power failure.

Further, since the EDLC has excellent charge/discharge efficiency and life compared to the secondary battery, relatively wide available temperature and voltage range, no need for maintenance, and environmentally friendly characteristics, the EDLC is being considered as a substitute for the secondary battery.

Generally, in case of the EDLC, as in the following FIG. 1, it is known that potentials of a cathode and an anode during charge/discharge are the same, and it is reported that a high voltage can be obtained by adjusting the potential of the cathode.

A currently known electrode potential adjusting method of the EDLC increases a voltage of a cell by differentiating weights of the cathode and the anode to make a difference in resistance between the cathode and the anode.

That is, as in the following FIG. 2, in case of using the same electrode active material, there is a method of adjusting thicknesses of a cathode active material 12 and an anode active material 22 in an electrode 30 consisting of a cathode 10 including the cathode active material 12 on a cathode current collector 11 and an anode 20 including the anode active material 22 on an anode current collector 11. In this case, the method is to increase the voltage of the cell through the resistance difference between the cathode 10 and the anode 20 by increasing the thickness of the cathode active material 12.

As another method, the electrode potential is adjusted by adjusting weights of the active materials applied on the cathode and the anode.

However, since it is impossible to effectively adjust a potential difference between the cathode and the anode by the currently used methods, there is a limit to improvement of the voltage or energy density of the EDLC cell.

### SUMMARY OF THE INVENTION

The present invention has been invented in order to overcome the above-described problems in manufacturing a high voltage electric double layer capacitor and it is, therefore, an object of the present invention to provide an electric double layer capacitor capable of improving energy density and a withstand voltage of a cell by adjusting a potential difference between a cathode and an anode.

In accordance with an embodiment of the present invention to achieve the object, there is provided an electric double layer capacitor characterized by using a cathode current collector and an anode current collector with different thicknesses.

In accordance with an embodiment of the present invention, it is preferred that the cathode current collector has a relatively small thickness compared to the anode current collector.

In accordance with an embodiment of the present invention, it is preferred that a thickness difference between the cathode current collector and the anode current collector is 5 to 30 μm.

The cathode current collector in accordance with the present invention may use a material selected from at least one metal selected from the group consisting of aluminum, stainless steel, titanium, tantalum, and niobium, etched metal, expanded metal, punched metal, nets, and foam.

The anode current collector in accordance with the present invention may use a material selected from at least one metal selected from the group consisting of aluminum, stainless steel, copper, nickel, and alloys thereof, etched metal, expanded metal, punched metal, nets, and foam.

The electric double layer capacitor in accordance with an embodiment of the present invention is characterized by including electrodes, which include active material layers on a cathode current collector and an anode current collector with different thicknesses.

It is preferred that a thickness difference between the cathode current collector and the anode current collector is 5 to 30 μm.

In accordance with an embodiment of the present invention, the electrode active materials included in the cathode current collector and the anode current collector may be equal to or different from each other, and each of them may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

In accordance with an embodiment of the present invention, it is most preferred that the electrode active materials included in the cathode current collector and the anode current collector are activated carbon with a specific surface area of 1.500 to 3.000 m²/g.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph of a potential value according to charge/discharge of a conventional electric double layer capacitor;

FIG. 2 is an example of a method of adjusting a potential of an electrode using a conventional method; and

FIG. 3 shows an electrode structure in accordance with an embodiment of the present invention.

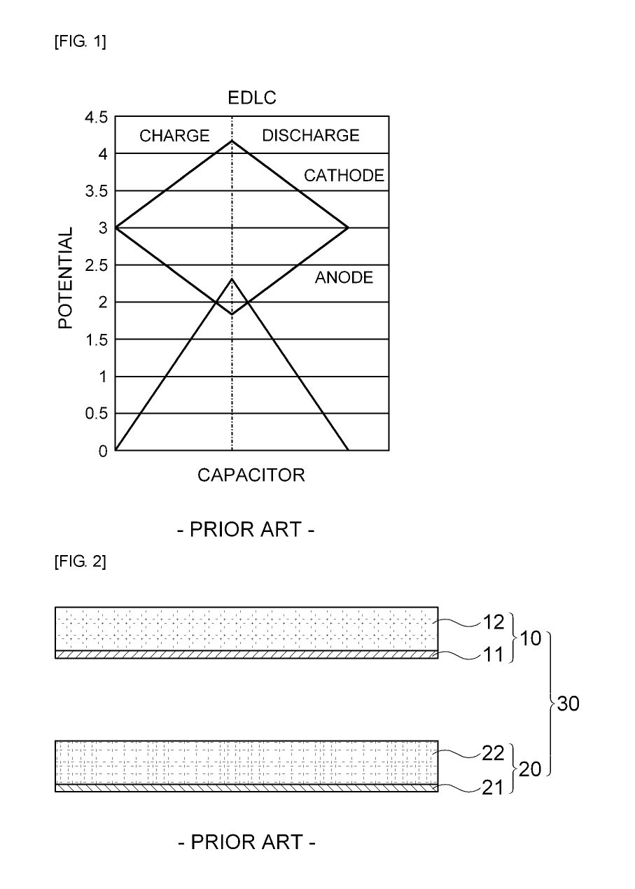

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

An electric double layer capacitor in accordance with the present invention is characterized by including electrodes using a cathode current collector and an anode current collector with different thicknesses.

As a method of adjusting a potential difference of a cell by changing an electrode structure of an electric double layer capacitor cell to make a difference in resistance between a cathode and an anode, the present invention uses a thickness difference between the current collectors used as the cathode and the anode. That is, the potential difference is adjusted through a method of reducing resistance of the anode by differentiating thicknesses of the current collectors of the cathode and the anode, that is, by reducing the thickness of the cathode and increasing the thickness of the anode.

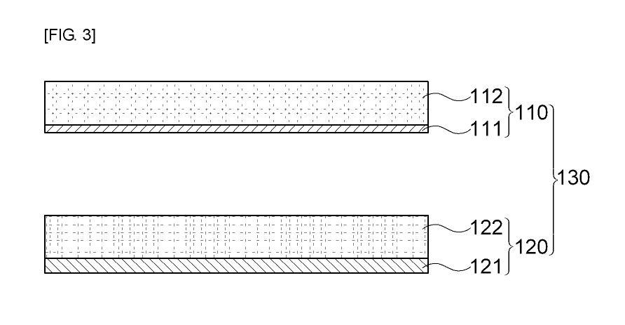

Specifically, referring to the following FIG. 3 which shows a portion of an electrode 130 structure in accordance with an embodiment of the present invention, the electrode 130 includes a cathode 110, which includes a cathode active material 112 on a cathode current collector 111, and an anode 120, which is formed by applying an anode active material 122 on an anode current collector 121. In the present invention, particularly, the thickness of the cathode current collector 111 and the thickness of the anode current collector 121 are different from each other.

In accordance with an embodiment of the present invention, it is preferred that the cathode current collector has a relatively small thickness compared to the anode current collector.

In accordance with an embodiment of the present invention, it is preferred that a thickness difference between the cathode current collector and the anode current collector is 5 to 30 μm. When the thickness difference between the cathode current collector and the anode current collector is less than 5 μm, it is not preferred since an effect to be pursued is insufficient due to a small resistance difference. When the thickness difference exceeds 30 μm, it is not preferred since energy density may be reduced. Therefore, it is preferred that the thickness difference between the cathode current collector and the anode current collector is 5 to 30 μm in the aspect that it is possible to increase capacity of the cell by improving a withstand voltage of the cell through the resistance difference between the cathode and the anode.

The cathode current collector in accordance with the present invention may be made of materials used in conventional electric double layer capacitors and lithium ion batteries, for example, at least one selected from the group consisting of aluminum, stainless steel, titanium, tantalum, and niobium. Among them, aluminum is preferable.

It is preferred that a thickness of the cathode current collector is 10 to 40 μm. In addition to the above metal foils, etched metal foils or materials such as expanded metal, punched metal, nets, and foam having holes penetrating front and rear surfaces can be used as the current collector.

Further, the anode current collector in accordance with the present invention may be made of all materials used in the conventional electric double layer capacitors and lithium ion batteries, for example, aluminum, stainless steel, copper, nickel, and alloys thereof. Among them, aluminum is preferable. Further, it is preferred that a thickness of the anode current collector is 10 to 40 μm. In addition to the above metal foils, etched metal foils or materials such as expanded metal, punched metal, nets, and foam having holes penetrating front and rear surfaces can be used as the current collector.

In the electric double layer capacitor in accordance with the present invention, the cathode, which is formed by applying cathode active material slurry including the cathode active material, a conductive agent, and a binder on the cathode current collector, and the anode, which is formed by applying anode active material slurry including the anode active material, the conductive agent, and the binder on the anode current collector, are immersed in an electrolytic solution while being insulated by a separator. At this time, the cathode current collector, which is relatively thin compared to the anode current collector, is used to adjust the potential difference between the electrodes.

Further, a mixture of the electrode active material, the conductive agent, and a solvent is formed into a sheet by the binder resin or a sheet extruded by extrusion is bonded to the current collector by a conductive adhesive.

The cathode active material and the anode active material used in the present invention may be equal to or different from each other, and each of them may be preferably at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

In accordance with a preferable embodiment of the present invention, it is most preferable to use activated carbon with a specific surface area of 1,500 to 3,000 m²/g among the above electrode active materials.

The conductive agent included in the cathode and anode active material slurry of the present invention may be conductive powder such as super-P, ketjen black, acetylene black, carbon black, and graphite but not limited thereto, and all kinds of conductive agents used in typical electrochemical capacitors can be included.

For example, the binder resin may be at least one selected from fluorine resins such as polytetrafluoroethylene (PTFE) and polyvinylidenfluoride (PVDF); thermoplastic resins such as polyimide, polyamideimide, polyethylene (PE), and polypropylene (PP); cellulose resins such as carboxymethyl cellulose (CMC); rubber resins such as styrene-butadiene rubber (SBR); and mixtures thereof but not particularly limited thereto, and all binder resins used in the typical electrochemical capacitors can be used.

The separator in accordance with the present invention may use all materials used in the conventional electric double layer capacitors or lithium ion batteries, for example, a microporous film manufactured from at least one polymer selected from the group consisting of polyethylene (PE), polypropylene (PP), polyvinylidenfluoride (PVDF), polyvinylidene chloride, polyacrynitrile (PAN), polyacrylamide (PAAm), polytetrafluoroethylene (PTFE), polysulfone, polyether sulfone (PES), polycarbonate (PC), polyamide (PA), polyimide (PI), polyethyleneoxide (PEO), polypropylene oxide (PPO), cellulose polymers, and polyacrylic polymers. Further, a multilayer film manufactured by polymerizing the porous film may be used, and among them, cellulose polymers may be preferably used.

It is preferred that a thickness of the separator is about 15 to 35 μm but not limited thereto.

The electrolytic solution of the present invention may be organic electrolytic solutions containing non-lithium salts such as spiro salts, TEABF₄ and TEMABF₄ or lithium salts such as LiPF₆, LiBF₄, LiCLO₄, LiN(CF₃SO₂)₂, CF₃SO₃Li, LiC(SO₂CF₃)₃, LiAsF₆, and LiSbF₆ or mixtures thereof. The solvent may be at least one selected from the group consisting of acrylonitrile, ethylene carbonate, propylene carbonate, dimethyl carbonate, ethyl methyl carbonate, sulfolane, and dimethoxyethane but not limited thereto. The electrolytic solution, in which these solute and solvent are mixed, has a high withstand voltage and high electrical conductivity. It is preferred that concentration of an electrolyte in the electrolytic solution is in the range of 0.1 to 2.5 mol/L, particularly 0.5 to 2.0 mol/L.

It is preferred that a case (exterior material) of the electrochemical capacitor of the present invention uses an aluminum-containing laminate film, which is typically used in the secondary batteries and the electric double layer capacitors, but not particularly limited thereto.

The electrochemical capacitor in accordance with the present invention may be more preferably used in the electric double layer capacitor but not particularly limited thereto.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### Embodiment 1

1) Preparation of Anode

Anode active material slurry, which is prepared by mixing and stirring vapor activated carbon (specific surface area 1800 m²/g) 123 g, super-P 15 g as a conductive agent, carboxymethyl cellulose (CMC) 3.8 g, styrene-butadiene rubber (SBR) 5.3 g, and polytetrafluoroethylene (PTFE) 2.2 g as binders, and water 473 g, is applied on an aluminum current collector with a thickness of 30 μm by a comma coater, temporarily dried, and cut to an electrode size of 50 mm×100 mm. A cross-sectional thickness of the electrode is 60 μm. Before assembly of a cell, the electrode is dried in a vacuum at 120° C. for 48 hours.

2) Preparation of Cathode

Cathode active material slurry, which has the same composition as the anode active material slurry prepared in the above 1), is applied on an etched aluminum foil current collector with a thickness of 20 μm by a comma coater, temporarily dried, and cut to an electrode size of 50 mm×100 mm. A cross-sectional thickness of the electrode is 60 μm. Before assembly of the cell, the electrode is dried in a vacuum at 120° C. for 48 hours.

3) Preparation of Electrolytic Solution

An electrolytic solution is prepared by dissolving a spiro salt in an acrylonitrile solvent so that concentration of the spiro salt is 1.3 mol/L.

4) Assembly of Electric Double Layer Capacitor Cell

The prepared electrodes (cathode, anode) are immersed in the electrolytic solution with a separator (TF4035 from NKK, cellulose separator) interposed therebetween and put in a laminate film case to be sealed.

### Comparative Example 1

An electric double layer capacitor is manufactured by the same process as the embodiment 1 except for using aluminum foil cathode and anode current collectors with the same thickness of 20 μm.

Experimental Example; Estimation of Capacity and Resistance of Electrochemical Capacitor Cell

Capacity of the last cycle is measured by charging electric double layer capacitor cells manufactured according to the embodiment 1 and the comparative example 1 to 2.5V at constant current and constant voltage with a current density of 1 mA/cm² and discharging the cells at constant current of 1 mA/cm² three times after 30 minutes under the condition of a constant temperature of 25° C., and measurement results are shown in the following table 1.

Further, resistance of each cell is measured by an ampere-ohm meter and an impedance spectroscopy, and measurement results are shown in the following table 1.

TABLE 1

| | Initial Capacity | Resistance |
|---|---|---|
| Classification | (F) | (AC ESR, mΩ) |
| Comparative | 1062 | 0.394 |
| Example 1 | | |
| Embodiment 1 | 1038 | 0.373 |

As in the results of the table 1, since a thickness difference between the aluminum current collectors is 10 μm, about 5% of resistance is generated from the current collector itself. By applying this to the cell, it is possible to improve a withstand voltage by making a difference in the thickness between the cathode and anode current collectors to adjust a potential difference of the electric double layer capacitor cell, thereby improving energy density of the cell.

According to the present invention, the cathode current collector is formed to be relatively thin compared to the anode current collector so that the electrode structure has the two electrode current collectors with different thicknesses. Therefore, it is possible to minimize capacity reduction compared to conventional methods and improve the energy density of the cell by improving the withstand voltage of the cell.

What is claimed is:

1. An electric double layer capacitor comprising a cathode current collector and an anode current collector with different thicknesses.

2. The electric double layer capacitor according to claim 1, wherein the cathode current collector has a relatively small thickness compared to the anode current collector.

3. The electric double layer capacitor according to claim 1, wherein a thickness difference between the cathode current collector and the anode current collector is 5 to 30 μm.

4. The electric double layer capacitor according to claim 1, wherein the cathode current collector uses a material selected from at least one metal selected from the group consisting of aluminum, stainless steel, titanium, tantalum, and niobium, etched metal, expanded metal, punched metal, nets, and foam.

5. The electric double layer capacitor according to claim 1, wherein the anode current collector uses a material selected from at least one metal selected from the group consisting of aluminum, stainless steel, copper, nickel, and alloys thereof, etched metal, expanded metal, punched metal, nets, and foam.

6. An electric double layer capacitor comprising electrodes including active material layers on a cathode current collector and an anode current collector with different thicknesses.

7. The electric double layer capacitor according to claim 6, wherein a thickness difference between the cathode current collector and the anode current collector is 5 to 30 μm.

8. The electric double layer capacitor according to claim 6, wherein the electrode active materials included in the cathode current collector and the anode current collector are equal to or different from each other, and each of the electrode active materials is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

9. The electric double layer capacitor according to claim 6, wherein the electrode active materials included in the cathode current collector and the anode current collector are activated carbon with a specific surface area of 1.500 to 3.000 m²/g.
